(19) United States
(12) Patent Application Publication
(10) Pub. No.: US 2009/0014925 A1
(43) Pub. Date: Jan. 15, 2009

(54) Method for manufacturing ceramic structure

(75) Inventors: Yasushi Noguchi, Nagoya-city (JP); Kyoko Makino, Nagoya-city (JP); Shuuji Ueda, Nagoya-city (JP)

Correspondence Address: OLIFF & BERRIDGE, PLC, P.O. BOX 320850, ALEXANDRIA, VA, 22320-4850, US

(73) Assignee: NGK Insulators, Ltd., Nagoya-city (JP)

(21) Appl. No.: 10/584,943

(22) PCT Filed: Jan. 11, 2005
(86) PCT No.: PCT/JP2005/000169

§ 371 Date: Jul. 5, 2006

(30) Foreign Application Priority Data
Jan. 13, 2004 (JP) 2004-005211

(51) Int. Cl. C04B 38/08

(52) U.S. Cl. 264/630; 264/603; 264/682

(57) ABSTRACT

A method for manufacturing a porous ceramic structure which comprises: mixing a ceramic material, a foamed resin and, if necessary, a forming auxiliary; forming the mixture; and then firing the thus formed body, wherein: a resin of an outer shell of the foamed resin is constituted of a copolymer containing 60 wt % or more of acrylonitrile and 40 wt % or less of methyl methacrylate.

### TECHNICAL FIELD

The present invention relates to a method for manufacturing a porous ceramic structure, more particularly to a ceramic structure manufacturing method capable of obtaining a ceramic structure having a high porosity comprising mixing a ceramic material and a foamed resin without using a large amount of combustible powder.

### BACKGROUND ART

Heretofore, there has been known a method for manufacturing a porous ceramic structure, in which combustible powder such as carbon, flour or resin is mixed with a ceramic material, the mixture is formed, and the resultant formed body is then fired to thereby burn and fly the combustible powder. However, according to this manufacturing method, in a case where a large amount of combustible powder is mixed with the ceramic material, there is a problem that cracks are generated in the ceramic structure during the firing.

Moreover, there is known a method for manufacturing a porous cordierite honeycomb structure by use of an organic foaming agent (see, e.g., Patent Document 1). However, in this method, there is a problem that the formed body is deformed during the foaming of the organic foaming agent because the organic forming agent needs to be heated to foam.

To solve the problem, the present applicant has proposed a method for manufacturing a ceramic structure, in which a foamed resin is added instead of the organic foaming agent to thereby suppress the deformation generated in the formed body during the foaming of the organic foaming agent (see, e.g., Patent Document 2). However, the conventional foamed resin has a problem that the amount of resin to be added has to be increased with an elapse of time, because a situation in which the porosity drops with the elapse of time after the foaming occurs.

Patent Document 1: Japanese Patent Application Laid-Open No. 9-77573: and

Patent Document 2: Japanese Patent Application Laid-Open No. 2002-326879.

### DISCLOSURE OF THE INVENTION

Therefore, the present invention has been developed in view of the above conventional problems, and an object thereof is to provide a porous ceramic structure manufacturing method capable of stably obtaining a ceramic structure having a high porosity even with an elapse of a predetermined or more storage period of a foamed resin.

That is, according to the present invention, there is provided a method for manufacturing a ceramic structure which comprises: mixing a ceramic material, a foamed resin and, if necessary, a forming auxiliary; forming the mixture; and then firing the thus formed body, wherein: as the foamed resin, there is used a material in which the weight of a gas included in the foamed resin stored at 40° C. for 4 weeks is 8% or more of the weight of the foamed resin.

Moreover, according to the present invention, there is provided a method for manufacturing a porous ceramic structure which comprises: mixing a ceramic material, a foamed resin and, if necessary, a forming auxiliary; forming the mixture; and then firing the thus formed body, wherein: as the foamed resin, there is used a material in which a weight decrease ratio of a gas included in the foamed resin stored at 40° C. for 4 weeks is 30% or less with respect to the weight of the gas before stored.

Furthermore, in the present invention, it is preferable that a resin of an outer shell of the foamed resin is constituted of a copolymer containing 60 wt % or more of acrylonitrile and 40 wt % or less of methyl methacrylate.

In addition, in the present invention, it is preferable that the resin of the outer shell of the foamed resin is constituted of a copolymer containing 60 wt % or more of acrylonitrile and 20 wt % or less of methyl methacrylate, and it is further preferable that the resin of the outer shell of the foamed resin is constituted of a copolymer containing 90 wt % or more of acrylonitrile and 10 wt % or less of methyl methacrylate.

Moreover, it is preferable that 80 wt % or more of the gas included in the foamed resin is a C5 component having 5 carbon atoms.

Furthermore, in the present invention, the resultant ceramic structure is preferably a honeycomb structure. Especially, the ceramic structure can constitute a honeycomb filter which has a plurality of through holes opened in an exhaust gas inflow-side end face and an exhaust gas outflow-side end face and in which the plurality of through holes are closed alternately in opposite end face portions.

Moreover, it is preferable that the ceramic structure is made of, as main components, cordierite, silicon carbide (SiC), and/or silicon carbide (SiC) and metallic silicon (Si).

In the present invention, the amount of the foamed resin to be added is preferably 0.5 to 10 wt %, further preferably 1 to 5 wt %. The average diameter of the foamed resin is preferably 2 to 200 μm, and the thickness of a shell wall of the foamed resin is preferably 0.01 to 1.0 μm.

According to the method for manufacturing the ceramic structure of the present invention, there is produced an excellent effect that the high-porosity ceramic structure can stably be obtained, even if the predetermined or more storage period of the foamed resin elapses.

### BEST MODE FOR CARRYING OUT THE INVENTION

The present invention will be described hereinafter in more detail in accordance with embodiments, but the present invention is not limited to these embodiments.

In the present invention, a ceramic material and a foamed resin are mixed. That is, instead of a conventional known foaming agent, the foamed resin already foamed (expanded) to contain bubbles therein is mixed with the ceramic material.

Moreover, the present inventors have intensively proceeded with investigation of the conventional constitution of the foamed resin in view of occurrence of a problem that if the storage period lengthens to a certain degree, a contained gas leaks to reduce a gas weight and, as a result, the porosity of a ceramic structure manufactured using this foamed resin drops below an intended numerical value.

As a result of the above investigation, the present inventors have found that when a resin constitution of an outer shell of the foamed resin is specified, the gas included in the resin is controlled to be low (little) even in a case where the foamed resin is stored for a predetermined or more period. In other words, the present inventors have found that the weight of the gas included in the resin is held to be not less than a predetermined weight of the foamed resin.

That is, in a first mode of the present invention, as the foamed resin, there is used a material in which the weight of the gas included in the foamed resin stored at 40° C. for 4 weeks is 8% or more, preferably 8% to 12%, especially preferably 8 to 11%.

Moreover, in a second mode of the present invention, as the foamed resin, there is used a material in which a weight decrease ratio of a gas included in the foamed resin stored at 40° C. for 4 weeks is 30% or less, preferably 25% or less, especially preferably 20% or less with respect to the weight of the gas before stored.

It is preferable that a resin of an outer shell of the foamed resin having such characteristics is constituted of a copolymer containing 60 wt % or more of acrylonitrile and 40 wt % or less of methyl methacrylate. It is more preferable that the resin of the outer shell is constituted of a copolymer containing 60 wt % or more of acrylonitrile and 20 wt % or less of methyl methacrylate. It is especially preferable that the resin of the outer shell is constituted of a copolymer containing 90 wt % or more of acrylonitrile and 10 wt % or less of methyl methacrylate. Accordingly, the weight decrease ratio of the included gas can effectively be reduced. The foamed resin of this material preferably has flexibility, and does not collapse under a pressure during mixing, kneading and/or forming.

Furthermore, in the present invention, as the gas included in the foamed resin, the foamed resin contains a gas component having 4 or 5 carbon atoms, such as isobutane (Cn=4) or isopentane (Cn=5), 80 wt % or more of the gas component is preferably a C5 component having 5 carbon atoms, such as isopentane (Cn=5), and 90 wt % or more of the gas component is further preferably the C5 component having 5 carbon atoms.

In the present invention, the amount of the foamed resin to be added is preferably 0.5 to 10 wt %, further preferably 1 to 5 wt % of the whole mixture (or plastic clay).

In addition, the average diameter of the foamed resin for use in the present invention is in a range of preferably 2 to 200 μm, further preferably 10 to 100 μm. When the average diameter of the foamed resin is smaller than 2 μm, the foamed resin enters gaps in the ceramic material, and an effect of forming pores in the ceramic structure lessens. When the average diameter of the foamed resin is larger than 200 μm, strength of the foamed resin weakens, the foamed resin easily collapses during the mixing, the kneading and/or the forming, and an effect of forming the pores lessens.

The thickness of a shell wall of the foamed resin is preferably 0.01 to 1.0 μm, further preferably 0.1 to 0.5 μm. When the thickness of the shell wall of the foamed resin is less than 0.01 μm, the foamed resin easily collapses, and the effect of forming pores lessens. On the other hand, when the thickness of the shell wall of the foamed resin is larger than 1.0 μm, the weight of the resin is increased. Therefore, there is a problem that cracks are easily generated during firing of a formed body.

It is to be noted that to a mixture (plastic clay), in addition to the foamed resin, graphite, resin powder such as polyethylene terephthalate (PET) or polymethyl methacrylate (PMMA) or the like can be added as a pore former, or a forming auxiliary (binder) such as methyl cellulose can be added. However, to inhibit the generation of the cracks during the firing, the amount of an organic material to be added, such as the resin or the binder, is preferably 20 wt % or less in total.

When the ceramic structure obtained in the present invention is a honeycomb structure having a structure in which a plurality of through holes opened in an exhaust gas inflow-side end face and an exhaust gas outflow-side end face are plugged alternately in opposite end face portions, it can preferably be used as an exhaust gas filter. There is not any special restriction on the shape of the honeycomb filter, and the filter may have any of: a columnar shape in which the shape of an end face is a perfect circle or an ellipse; a square rod shape in which the shape of an end face is a polygon such as a triangle or a quadrangle; and a shape in which a side surface of the columnar shape or the square rod shape is curved into a V-shape. There is not any special restriction on the shape of the through hole, and a sectional shape of the hole may be any of a polygon such as a quadrangle or an octagon, a perfect circle and an ellipse. A filter cell density is in a range of preferably 200 cells/in² or more, further preferably 250 to 400 cells/in² in respect of a pressure loss of an exhaust gas.

There is not any special restriction on main components of the ceramic structure, and any type of ceramic material is usable, but it is preferable that cordierite, silicon carbide (SiC), and/or silicon carbide (SiC) and metallic silicon (Si) are main components. Cordierite may be oriented, non-oriented, α-crystalline, or β-crystalline. Silicon carbide may be α-crystalline or β-crystalline.

Moreover, the structure may contain another component such as mullite, zircon, aluminum titanate, clay-bonded silicon carbide, zirconia, spinel, indialite, sapphirine, corundum or titania.

In the present invention, the above ceramic material and the foamed resin are mixed and formed. Any known forming method may be used, but to produce the structure more efficiently and raise the effect of the foamed resin, it is preferable that the binder, the foamed resin, a plasticizer and water are introduced and kneaded to form the plastic clay. Subsequently, the plastic clay is formed, and the forming can be performed by an extrusion molding method, an injection molding method, a press molding method, a method of forming the ceramic material into a columnar shape and forming the through holes or the like. Above all, it is preferable to perform the extrusion molding method, because continuous forming is facilitated and thermal expansion property of the product can be lowered by orientating the cordierite crystals, for example. As the extrusion method, vertical press molding is preferable in which the material is extruded downwards in a vertical direction in order to inhibit deformation after the forming. In a case where the formed body is a small-diameter body, lateral press molding can be used in which the material is extruded in a lateral direction. However, in a case where the formed body is a large-diameter body, vertical press molding is preferable in which the material is extruded downwards in a vertical direction in order to inhibit the deformation after the forming.

Subsequently, a green formed body can be dried by hot-air drying, micro-wave drying, dielectric drying, reduced-pressure drying, vacuum drying, freeze drying or the like. Above all, it is preferable to perform a drying step constituted by combining the hot-air drying with the micro-wave drying or the dielectric drying because the whole body can be dried quickly and uniformly.

Finally, conditions for firing the dried formed body depend on the size of the dried formed body. Usually, in a case where the ceramic material contains cordierite as a main component, it is preferable to fire the body in an outside air atmosphere at a temperature of 1410 to 1440° C. In a case where the ceramic material contains SiC as a main component, the body is fired in a non-oxidizing atmosphere of N₂, Ar or the like in order to prevent SiC from being oxidized. In a case where SiC is combined with silicon nitride or the like, a firing temperature is preferably a temperature at which silicon nitride powder softens. It is preferable to fire the body at a temperature of 1550 to 2000° C. In a case where SiC particles are combined with one another by a recrystallization method, it is necessary to fire the body at a temperature of at least 1800° C. Furthermore, in a case where the ceramic material contains SiC and Si as main components, it is preferable to fire the material at a temperature of 1400 to 1800° C. in a non-oxidizing atmosphere such as N₂ or Ar. It is to be noted that the drying step and the firing step may continuously be performed.

### EXAMPLES

The present invention will be described hereinafter in further detail in accordance with examples, but the present invention is not limited to the examples. It is to be noted that the foamed resin storage conditions of examples and comparative examples, the porosity of the resultant honeycomb filter, and an included gas amount were measured on the following conditions and by the following methods.

(1) A foamed resin was stored in a sealed constant-temperature tank set at 40° C. or 20° C.

(2) An average pore diameter was measured with a mercury intrusion type porosimeter manufactured by Micromeritics Co., and a porosity was converted from a total pore volume (at this time, the true specific gravity of cordierite was set to 2.52).

(3) The foamed resin was sufficiently dried in a desiccator, and a dried weight W1 was measured. Thereafter, acetone which was a foamed resin solvent was added to the foamed resin, and the resin was dissolved to fly and scatter an included gas. After acetone and the included gas were sufficiently flied and scattered, a weight w2 was measured. An included gas amount w_{g} (weight %) was calculated by the following equation.

w_{g}=(w1−w2)/w1.

### Example 1

To a cordierite forming material made of talc, kaolin, alumina, aluminum hydroxide and silica, there were added: 2.0 wt % of a copolymer foamed resin having an average diameter of 50 μm and a shell wall thickness of 0.2 μm, containing 60 wt % of acrylonitrile (AN) and 40 wt % of methyl methacrylate (MMA) (an included gas was a mixed gas of isobutane (Cn=4) and isopentane (Cn=5), a C5 component content was 95 wt %) and stored at 40° C. for 4 weeks; 5 wt % of a water-soluble cellulose derivative; 0.5 wt % of a surfactant; and water. The material was kneaded with a kneader, and columnar plastic clay deaerated with a clay kneader was obtained. This columnar plastic clay was extruded to obtain a honeycomb body having a diameter of 300 mm, a partition wall thickness of 300 μm and a cell number of 300 in⁻². A dried body was cut into a length of 350 mm, and opposite end face portions were alternately closed with paste of the cordierite forming material to obtain a zigzag pattern. This body was fired in a single kiln firing furnace at a maximum temperature of 1420° C. for 150 hours on schedule. As a result, there was obtained a satisfactory honeycomb filter constituted of a cordierite fired body in which any crack was not generated during the firing. Table 1 shows a foamed resin storage period, the amount of the included gas before and after the storage, and the porosity of the resultant honeycomb filter.

### Examples 2 to 5

Cylindrical clay was prepared in the same manner as in Example 1 except that a resin constituting ratio of an outer shell of a foamed resin, an included gas amount, a C5 component content of the included gas and a storage period were changed as shown in Table 1. This clay was extruded into a honeycomb shape and fired to obtain a honeycomb filter in the same manner as in Example 1. Table 1 shows the amount of the included gas before and after the storage, and the porosity of the resultant honeycomb filter.

### Comparative Example 1

Cylindrical clay was prepared on substantially the same conditions as those of Example 1 except that a resin constituting ratio of an outer shell of a foamed resin and a C5 component content of an included gas were changed as shown in Table 1. This clay was extruded into a honeycomb shape and fired to obtain a honeycomb filter in the same manner as in Example 1. Table 1 shows porosity and a gas weight decrease ratio of the resultant honeycomb filter.

Comparative Example 1 indicates a large gas weight decrease ratio of 64% as compared with Examples 1 to 5. Therefore, the porosity of the resultant honeycomb filter remained at a low value of 63%.

### Comparative Example 2

Cylindrical clay was prepared using foamed resin characteristics similar to those of Comparative Example 1 except that the amount of a foamed resin to be added was increased as shown in Table 1. This clay was extruded into a honeycomb shape and fired to obtain a honeycomb filter in the same manner as in Comparative Example 1. Table 1 shows porosity and a gas weight decrease ratio of the resultant honeycomb filter.

As compared with Examples 1 to 5, in Comparative Example 2, when the foamed resin is added as much as 2.4 wt %, the porosity of the honeycomb filter can be increased to 65%. However, when a large amount of foamed resin is added, problems occur that a formed body is deformed and that firing becomes difficult.

(Evaluation)

As seen from the above results of Examples 1 to 5 and Comparative Examples 1 and 2, in a case where the ceramic structure was manufactured using the foamed resin which was constituted of the specific material as in the present invention and in which the included gas weight was reduced to 8% or more of the foamed resin weight and the included gas weight decrease ratio was reduced to 25% or less, when 1.9 wt % of foamed resin was added, it was possible to raise the porosity of the structure to 65% or more.

TABLE 1

| | Foamed resin characteristics | | | | | | | | | |
|---|---|---|---|---|---|---|---|---|---|---|
| | | | Included | | | | | | | |
| | Foamed | Foamed | gas | Foamed | Foamed | Included | Gas | Content of | Amount of | |
| | resin | resin | amount | resin | resin | gas amount | weight | C5 | foamed | |
| | AN | MMA | before | storage | storage | after | decrease | component | resin to | Honeycomb |
| | amount | amount | storage | temperature | period | storage | ratio | in included | be added | porosity |
| | (wt %) | (wt %) | (wt %) | (° C.) | (weeks) | (wt %) | (%) | gas (wt %) | (wt %) | (%) |
| Example 1 | 60 | 40 | 12 | 40 | 4 | 9 | 25 | 95 | 1.9 | 65 |
| Example 2 | 80 | 20 | 12 | 40 | 4 | 10 | 17 | 90 | 1.9 | 65 |
| Example 3 | 90 | 10 | 9 | 40 | 4 | 8 | 11 | 90 | 1.9 | 67 |
| Example 4 | 90 | 10 | 13 | 40 | 4 | 11 | 15 | 95 | 1.9 | 68 |
| Example 5 | 90 | 10 | 9 | 20 | 1 | 9 | 0 | 90 | 1.9 | 66 |
| Comparative | 50 | 50 | 11 | 40 | 4 | 4 | 64 | 60 | 1.9 | 63 |
| Example 1 | | | | | | | | | | |
| Comparative | 50 | 50 | 11 | 40 | 4 | 4 | 64 | 60 | 2.4 | 65 |
| Example 2 | | | | | | | | | | |

### INDUSTRIAL APPLICABILITY

According to the present invention, there can be provided a method for manufacturing a porous ceramic structure, more particularly to a method for manufacturing a ceramic structure, in which when a ceramic material and a foamed resin are mixed, a high-porosity ceramic structure can stably be obtained without using a large amount of combustible powder.

1-11. (canceled)

12. A method for manufacturing a porous ceramic structure which comprises: mixing a ceramic material, a foamed resin and, if necessary, a forming auxiliary; forming the mixture; and then firing the thus formed body, wherein:
as the foamed resin, there is used a material in which the weight of a gas included in the foamed resin stored at 40° C. for 4 weeks is 8% or more of the weight of the foamed resin.

13. A method for manufacturing a porous ceramic structure which comprises: mixing a ceramic material, a foamed resin and, if necessary, a forming auxiliary; forming the mixture; and then firing the thus formed body, wherein:
as the foamed resin, there is used a material in which a weight decrease ratio of a gas included in the foamed resin stored at 40° C. for 4 weeks is 30% or less with respect to the weight of the gas before stored.

14. The method for manufacturing the ceramic structure according to claim 12, wherein a resin of an outer shell of the foamed resin is constituted of a copolymer containing 60 wt % or more of acrylonitrile and 40 wt % or less of methyl methacrylate.

15. The method for manufacturing the ceramic structure according to claim 13, wherein a resin of an outer shell of the foamed resin is constituted of a copolymer containing 60 wt % or more of acrylonitrile and 40 wt % or less of methyl methacrylate.

16. The method for manufacturing the ceramic structure according to claim 14, wherein the resin of the outer shell of the foamed resin is constituted of a copolymer containing 60 wt % or more of acrylonitrile and 20 wt % or less of methyl methacrylate.

17. The method for manufacturing the ceramic structure according to claim 15, wherein the resin of the outer shell of the foamed resin is constituted of a copolymer containing 60 wt % or more of acrylonitrile and 20 wt % or less of methyl methacrylate.

18. The method for manufacturing the ceramic structure according to claim 14, wherein the resin of the outer shell of the foamed resin is constituted of a copolymer containing 90 wt % or more of acrylonitrile and 10 wt % or less of methyl methacrylate.

19. The method for manufacturing the ceramic structure according to claim 15, wherein the resin of the outer shell of the foamed resin is constituted of a copolymer containing 90 wt % or more of acrylonitrile and 10 wt % or less of methyl methacrylate.

20. The method for manufacturing the ceramic structure according to claim 12, wherein 80 wt % or more of the gas included in the foamed resin is a C5 component having 5 carbon atoms.

21. The method for manufacturing the ceramic structure according to claim 13, wherein 80 wt % or more of the gas included in the foamed resin is a C5 component having 5 carbon atoms.

22. The method for manufacturing the ceramic structure according to claim 12, wherein the ceramic structure is a honeycomb structure.

23. The method for manufacturing the ceramic structure according to claim 13, wherein the ceramic structure is a honeycomb structure.

24. The method for manufacturing the ceramic structure according to claim 12, wherein the ceramic structure is a honeycomb filter which has a plurality of through holes opened in an exhaust gas inflow-side end face and an exhaust gas outflow-side end face and in which the plurality of through holes are closed alternately in opposite end face portions.

25. The method for manufacturing the ceramic structure according to claim 13, wherein the ceramic structure is a honeycomb filter which has a plurality of through holes opened in an exhaust gas inflow-side end face and an exhaust gas outflow-side end face and in which the plurality of through holes are closed alternately in opposite end face portions.

26. The method for manufacturing the ceramic structure according to claim 12, wherein the ceramic structure is made of, as main components, cordierite, silicon carbide (SiC), and/or silicon carbide (SiC) and metallic silicon (Si).

27. The method for manufacturing the ceramic structure according to claim 13, wherein the ceramic structure is made of, as main components, cordierite, silicon carbide (SiC), and/or silicon carbide (SiC) and metallic silicon (Si).

28. The method for manufacturing the ceramic structure according to claim 12, wherein the average diameter of the foamed resin is in a range of 2 to 200 mm.

29. The method for manufacturing the ceramic structure according to claim 13, wherein the average diameter of the foamed resin is in a range of 2 to 200 mm.

30. The method for manufacturing the ceramic structure according to claim 12, wherein the thickness of a shell wall of the foamed resin is in a range of 0.01 to 1.0 mm.

31. The method for manufacturing the ceramic structure according to claim 13, wherein the thickness of a shell wall of the foamed resin is in a range of 0.01 to 1.0 mm.
